(19) United States
(12) Patent Application Publication
(10) Pub. No.: US 2005/0251841 A1
(43) Pub. Date: Nov. 10, 2005

(54) Radio frequency signal loopback in a cable modem termination system

(75) Inventors: Andrew R. Boyce, Groton, MA (US); Clarke V. Greene, Middletown, CT (US); J. David Unger, Windham, NH (US)

Correspondence Address: Fogg and Associates, LLC, P.O. Box 581339, Minneapolis, MN, 55458-1339, US

(73) Assignee: ADC Broadband Access Systems, Inc.

(21) Appl. No.: 10/838,450

(22) Filed: May 4, 2004

(51) Int. Cl. H04N 7/173

(52) U.S. Cl. 725/111; 725/126

(57) ABSTRACT

A cable modem termination system includes an upstream radio frequency interface having a plurality of upstream radio frequency signal inputs and a downstream radio frequency interface having a downstream radio frequency signal output. The downstream radio frequency signal output is selectively coupled to at least one of the plurality of upstream radio frequency signal inputs.

### TECHNICAL FIELD

The following description relates to telecommunications in general and to cable networks in particular.

### BACKGROUND

A cable modem termination system (CMTS) is typically located in a head end of a cable network. Several cable modems are coupled to the CMTS using a hybrid fiber coax (HFC) network infrastructure included in the cable network. The CMTS typically couples the cable modems to a wide area network such as the Internet. The CMTS processes downstream data transmitted to, and upstream data received from, the several cable modems. In one embodiment, several cable modem termination systems are housed in a single chassis.

One goal of cable service providers is to improve system reliability and availability. One way in which system reliability and availability is improved is to provide a backup or secondary CMTS. In one configuration (referred to here as an “N+1” configuration), each of a group of primary cable modem termination systems services a separate group of cable modems. In the event that one of the primary cable modem termination systems is unable to service its group of cable modems, the backup cable modem termination system is coupled to the group of cable modems associated with that primary CMTS. The backup CMTS then services that group of cable modems. In another configuration (referred to here as a “1+1” configuration), each primary CMTS has a separate backup CMTS that serves as a backup for that primary CMTS.

As used herein, a “switchover” occurs when a backup CMTS takes over for a failed primary CMTS. In order for a switchover to be successful, the backup CMTS module must be operational when the switchover occurs.

### SUMMARY

In one embodiment, a cable modem termination system includes an upstream radio frequency interface having a plurality of upstream radio frequency signal inputs and a downstream radio frequency interface having a downstream radio frequency signal output. The downstream radio frequency signal output is selectively coupled to at least one of the plurality of upstream radio frequency signal inputs.

In another embodiment, a system includes a plurality of cable modem termination systems. Each cable modem termination system includes an upstream radio frequency interface having a plurality of upstream radio frequency signal inputs. Each cable modem termination system further includes a downstream radio frequency interface that generates a downstream radio frequency signal and comprises a downstream radio frequency output on which the downstream radio frequency signal is output. When each of the plurality of cable modem termination systems acts as an active cable modem termination system, that cable modem termination system is selectively coupled to a cable network and the network interface in order to receive a plurality of upstream radio frequency signals from the cable network, to transmit a downstream radio frequency signal to the cable network, to receive downstream network data from the first network, and to transmit upstream network data to the first network. When each of the plurality of cable modem termination systems acts as a backup cable modem termination system, the downstream radio frequency signal output of that cable modem termination system is selectively coupled to at least one of the plurality of upstream radio frequency signal inputs of that cable modem termination system.

In another embodiment, a method includes determining if a cable modem termination system is in a first mode. The method further includes, when the cable modem termination system is in the first mode, establishing a loopback path between a downstream radio frequency interface of the cable modem termination system and an upstream radio frequency interface of the cable modem termination system and transmitting a radio frequency signal on the loopback path.

In another embodiment, a cable modem termination system includes an upstream means for receiving a plurality of upstream radio frequency signals, a downstream means for generating a downstream radio frequency signal, and a loopback means for selectively coupling the downstream radio frequency signal to the upstream means.

The details of one or more embodiments of the claimed invention are set forth in the accompanying drawings and the description below. Other features and advantages will become apparent from the description, the drawings, and the claims.

### DRAWINGS

FIG. 1 is a block diagram of one embodiment of a cable system.

FIG. 2A is a block diagram of one embodiment of a cable modem termination system.

FIGS. 2B-2C are block diagrams of the embodiment of a cable modem termination system shown in FIG. 2A while such cable modem termination system is acting as a backup cable modem termination system.

FIG. 3 is a flow diagram of one embodiment of a method of monitoring a cable modem termination system while the cable modem termination system is in backup mode.

FIG. 4 is a flow diagram of one embodiment of a method of operating a loopback switch circuit of a cable modem termination system.

FIG. 5 is a block diagram of one embodiment of a loopback switch circuit.

Like reference numbers and designations in the various drawings indicate like elements.

### DETAILED DESCRIPTION

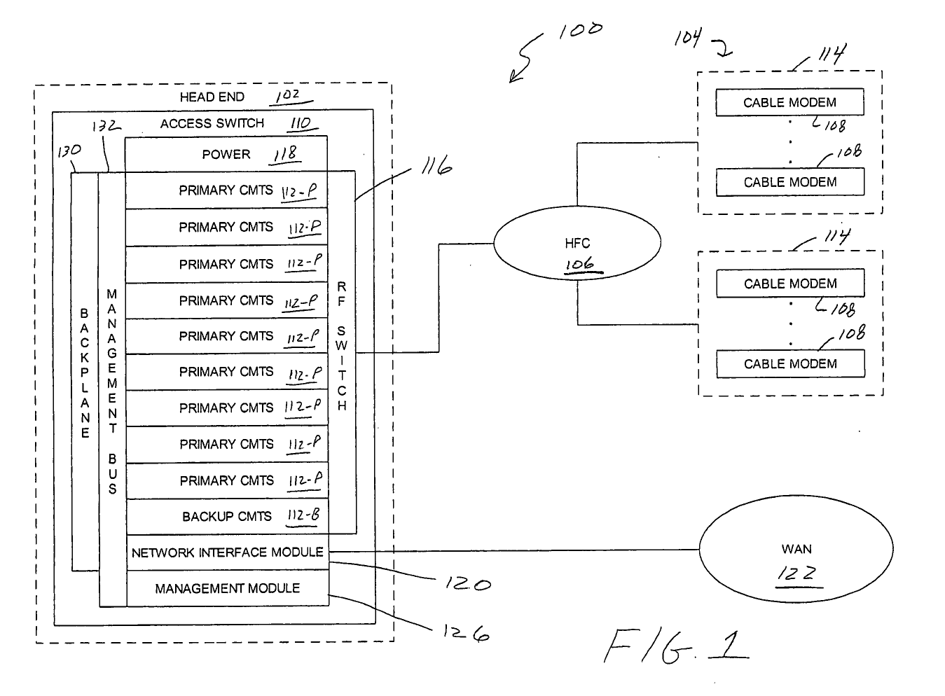

FIG. 1 is a block diagram of one embodiment of a cable system 100 in which embodiments described here are implemented. Cable system 100 includes a head end 102 that communicates with several items of customer premises equipment 104 using a hybrid fiber coax infrastructure 106. The customer premises equipment 104 includes, for example, a cable modem 108. In other embodiments, the customer premise equipment 104 includes, for example, a multimedia terminal adapter (MTA) or a residential gateway. The head end 102 includes an access switch 110. Access switch 110 typically includes a chassis that houses multiple cable modem termination systems 112. In one implementation, each cable modem termination system 112 is located on a blade that is inserted into the chassis of the access switch 110.

In the embodiment shown in FIG. 1, the multiple cable modem termination systems 112 include N primary cable modem termination systems 112-P and one backup cable modem termination system 112-B. In the embodiment shown in FIG. 1, N is greater than one and the access switch 110 implements an N+1 redundancy system. In one exemplary implementation of such an embodiment, N is equal to nine. Each of the primary cable modem termination systems 112-P is coupled to a separate group 114 of cable modems 108 over the hybrid fiber coax infrastructure 106 of the cable system 100. An RF switch 116 interfaces each of the primary cable modem termination systems 112-P to the group 114 of cable modems 108 serviced by that primary CMTS 112-P. In one implementation of such an embodiment, the RF switch 116 is a part of the access switch 110 and implemented on a mezzanine board.

In the event that one of the primary cable modem termination systems 112-P is inoperable or is otherwise unable to service appropriately the group 114 of cable modems 108 assigned to that primary cable modem termination system 112-P, the backup cable modem termination system 112-B is coupled to that group 114 of cable modems 108 by the RF switch 116 instead of, or in addition to, the primary cable modem termination system 112-P. The backup cable modem termination system 112-B then services the group 114 of cable modems 108 instead of, or in addition to, that primary cable modem termination system 112-P.

The access switch 110 also includes one or more power supplies 118 that provide power to the various components of the access switch 110. The access switch 110 includes one or more network interface modules 120 that couple the access switch 110 to a wide area network (WAN) 122. For example, in one embodiment, WAN 122 includes a SONET ring coupling the access switch 110 to the Internet and a public switched telephone network. The access switch 110 also includes a backplane 130 (for example, a mesh backplane) that couples the various cable modem termination systems 112 and the network interface modules 120 to one another.

In the upstream direction, each of the primary cable modem termination systems 112-P receives upstream traffic from the group 114 of cable modems 108 serviced by that primary cable modem termination system 112-P. Any of the received upstream traffic that is destined for the WAN 122 is forwarded by the primary cable modem termination system 112-P over the backplane 130 to an appropriate network interface module 120. The network interface module 120 forwards the received upstream traffic to the WAN 122. In the downstream direction, downstream traffic is received from the WAN 122 by the network interface module 120. The network interface module 120 forwards the downstream traffic destined for each primary cable modem termination system 112-P over the backplane 130 to that primary cable modem termination system 112-P. Each primary cable modem termination system 112-P receives from the backplane 130 the downstream traffic forwarded to that primary cable modem termination system 112-P and transmits the received downstream traffic to the group 114 of cable modems 108 serviced by that primary cable modem termination system 112-P.

The access switch 110 also includes at least one management module 126 that, in one embodiment, runs software that monitors and controls the operation of the access switch 110 and the modules inserted therein. The access switch 110, in the embodiment shown in FIG. 1, includes at least one management bus 132 over which the management module 126 communicates with the modules inserted into the access switch 110.

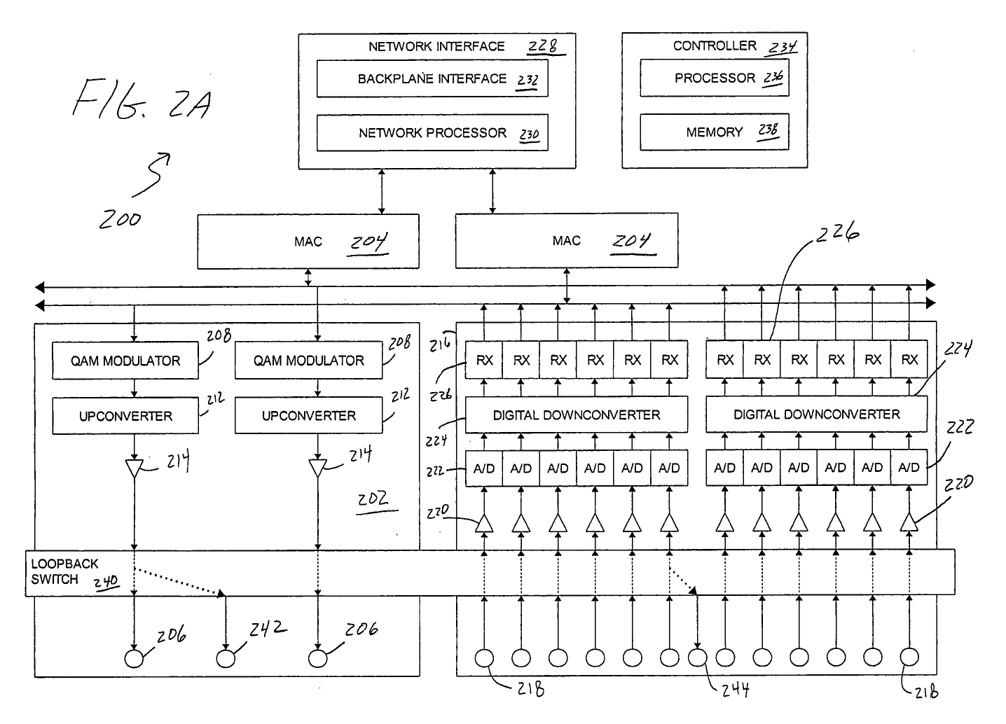

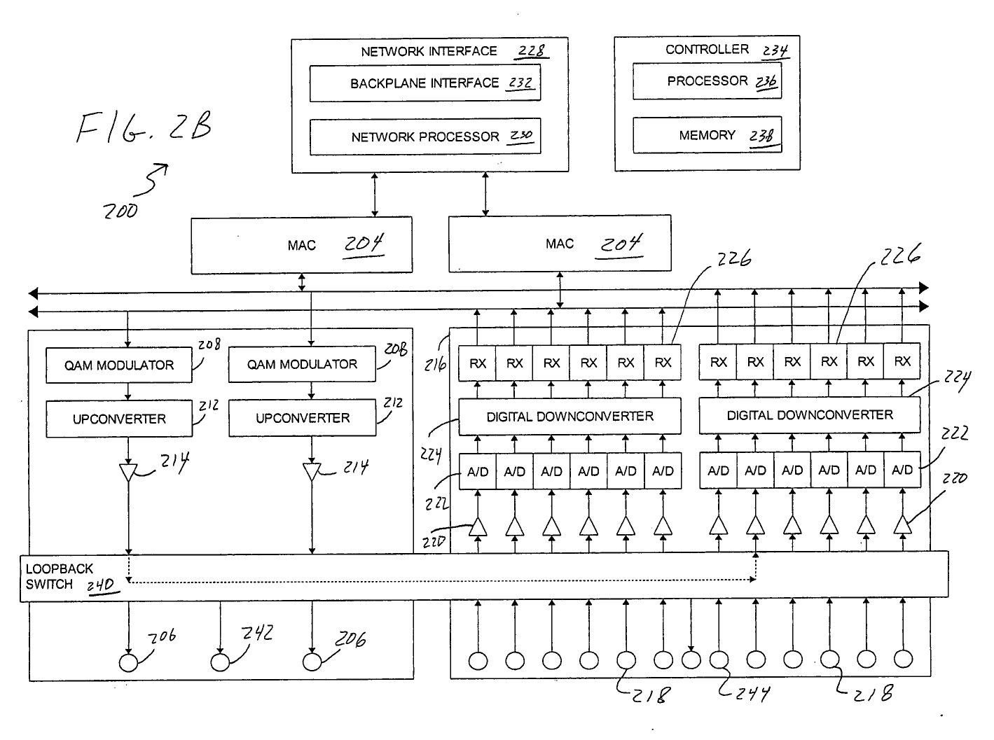

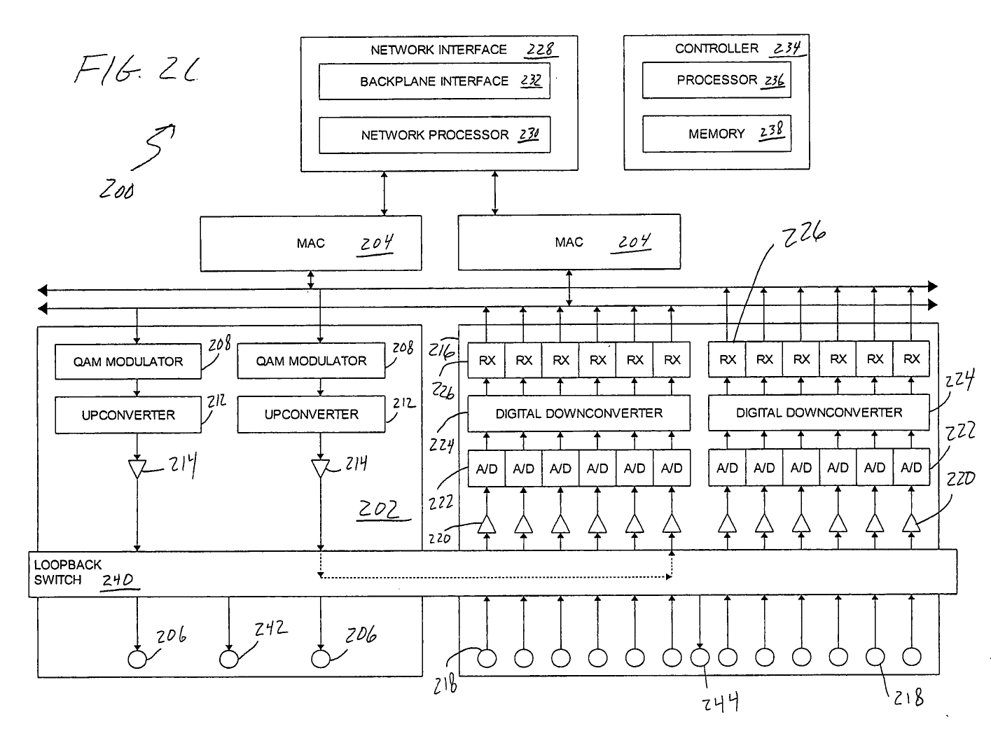

FIG. 2A is a block diagram of one embodiment of a cable modem termination system 200 suitable for use in the cable system 100 as a primary CMTS 112-P or a backup CMTS 112-B. Cable modem termination system 200 includes a downstream radio frequency (RF) interface 202 that couples one or more media access control (MAC) devices 204 to the group 114 of cable modems 108 (shown in FIG. 1) serviced by the CMTS 200. The downstream RF interface 202 includes one or more downstream ports 206 that provide an interface between the downstream RF interface 202 and the RF switch 116 used to couple the CMTS 200 to the HFC infrastructure 106. In one implementation, each downstream port 206 includes an ‘F’ connector. In the embodiment shown in FIG. 2A, the CMTS 200 includes two MAC devices 204 and the downstream RF interface 202 includes two downstream ports 206. Each of the MAC devices 204 is coupled to a respective downstream port 206 in order to transmit downstream traffic to a subset of the group of cable modems serviced by that CMTS 200. Each such subset of cable modems is coupled to a respective downstream port 206 via the HFC infrastructure 106 (shown in FIG. 1).

Each MAC device 204 is coupled to a respective downstream port 206 via a quadrature amplitude modulation (QAM) modulator 208 and an upconverter 212. Downstream digital packets intended for the subset of cable modems serviced by each MAC device 204 forwarded to a respective QAM modulator 208. Each QAM modulator 208 converts the digital data signal received from the corresponding MAC device 204 to modulated analog frames using quadrature amplitude modulation (for example, 64 QAM or 256 QAM), forward error correcting (FEC) code, and packet interleaving. Each upconverter 212 upconverts a downstream analog signal received from a respective modulator 208. In one implementation supporting DOCISIS, the upconverted signal is upconverted into a 6 megahertz channel in the frequency range of approximately 88 megahertz to approximately 860 megahertz.

For each MAC device 204, the respective upconverted RF signal is amplified by an amplifier 214. Each amplified RF signal is output on a respective downstream port 206 to the RF switch 116 (shown in FIG. 1). In the embodiment shown in FIG. 2A, each amplified RF signal is coupled to a respective downstream port 206 via a loopback switch circuit 240 (described below). The RF switch 116 couples the electrical RF signal output on each downstream port 206 to an electrical-to-optical converter (not shown) that converts the electrical RF signal to an optical signal suitable for transmission on the HFC infrastructure 106 to the subset of cable modems 108 serviced by the corresponding MAC device 204.

The CMTS 200 also includes an upstream radio frequency (RF) interface 216 that couples each MAC device 204 to the subset of cable modems 108 serviced by that MAC device 204. The upstream RF interface 216 includes multiple upstream ports 218 that provide an interface between the upstream RF interface 216 and the RF switch 116 used to couple the CMTS 200 to the HFC infrastructure 106. In one implementation, each upstream port 218 includes an ‘F’ connector. Upstream traffic from the cable modems serviced by the CMTS 200 is received on the upstream ports 218. In the implementation shown in FIG. 2A, the upstream RF interface 216 includes six upstream ports 218 for each MAC device 204. Each subset of cable modems is coupled to a respective set of upstream ports 218 via the HFC infrastructure 106 (shown in FIG. 1).

The upstream RF interface 216 receives an upstream analog RF signal on each of the upstream ports 218. Each upstream analog RF signal includes an upstream channel that is, for example, 3.2 megahertz wide (in the case of DOCSIS 1.0 and 1.1) or 6 megahertz wide (in the case of DOCSIS 2.0) and is in the frequency range of 5 megahertz to 42 megahertz. Each upstream port 218 is coupled to an amplifier 220 that amplifies the upstream analog RF signal received on that upstream port 218. In the embodiment shown in FIG. 2A, each upstream port 218 is coupled to a respective upstream amplifier 220 via the loopback switch circuit 240 (described below). Each amplifier 220 is coupled to a respective analog-to-digital converter 222 that converts the amplified upstream analog RF signal to a digital signal.

Each analog-to-digital converter 222 is coupled to a digital downconverter 224. In the embodiment shown in FIG. 2A, the digital downconverter processing for all the upstream digital signals for each MAC device 204 is performed by a single digital downconverter application-specific integrated circuit. For each upstream digital signal, the digital downconverter 224 down converts the digital signal to a baseband or intermediate frequency digital signal.

For each upstream signal, the output of the digital downconverter 224 is a modulated signal (for example, a QPSK, 16 QAM, or 64 QAM modulated signal) that is demodulated by one of multiple receivers 226. In the implementation shown in FIG. 2A, there is one receiver 226 for each upstream channel serviced by the CMTS 200. The demodulated digital data is transmitted to a corresponding MAC device 204 for subsequent processing and forwarding.

The CMTS 200 includes a network interface 228 that couples the CMTS 200 to one or more network interface modules 120 (shown in FIG. 1) over the backplane 130 of the access switch 110 in which the CMTS 200 is housed. The network interface 228 includes a network processor 230 that forwards packets to and from the backplane 130 and the MAC devices 204. The network interface 228 also includes a backplane interface 232 that couples the network processor 230 to the backplane 130 of the access switch 110.

The CMTS 200 also includes a controller 234. In the embodiment shown in FIG. 2A, controller 234 includes a programmable processor 236 that is coupled to memory 238. In one implementation, memory 238 includes random access memory, read only memory, and processor registers, though it is to be understood that other types of memory are used in other implementations. Program instructions that are executed on the programmable processor 236 and associated data structures are stored in memory 238. Some embodiments of the methods described here are implemented by adapting the controller 234 (for example, by programming programmable processor 236) to carry out at least a portion of the processing used in such embodiments. The various components of the CMTS 200 are coupled to one another as needed using appropriate interfaces (not shown in FIG. 2A). Such interfaces includes, for examples, buses, ports, and the like.

When the CMTS 200 is acting as a primary CMTS and is servicing a group 114 of cable modems 108 (also referred to here as “active mode”), the loopback switch circuit 240 selectively couples the amplified downstream RF signal output by each amplifier 214 to a respective downstream port 206. Such an operational state is shown in FIG. 2A using dashed lines. In addition, the loopback switch circuit 240 selectively taps any one (or none) of the amplified downstream RF signals and couples that signal to a downstream test port 242. This is shown in FIG. 2A using a dotted line. In one implementation, the downstream test port 242 is mounted on the front faceplate of the CMTS 200 in order to provide convenient access to the port 242. This provides a point at which a technician can attach test equipment to monitor one of the amplified downstream RF signals when the CMTS 200 is operating in active mode.

Likewise when the CMTS 200 is operating in active mode, the loopback switch circuit 240 selectively couples each upstream analog RF signal received at an upstream port 218 to a respective amplifier 220. Such an operational state is shown in FIG. 2A using dashed lines. In addition, the loopback switch circuit 240 selectively taps any one (or none) of the upstream analog RF signals and couples that signal to an upstream test port 244. This is shown in FIG. 2A using a dotted line. In one implementation, the upstream test port 244 is mounted on the front faceplate of the CMTS 200 in order to provide convenient access to the port 244. This provides a point at which a technician can attach test equipment to monitor one of the upstream RF signals when the CMTS 200 is operating in active mode.

When the CMTS 200 is acting as a backup CMTS and is not serving a group 114 of cable modems 108 (also referred to here as “backup mode”), the loopback switch circuit 240 selectively couples any one (or none) of the amplified downstream RF signals output by a respective amplifier 214 to any one upstream amplifiers 220. In other words, the loopback switch circuit 240 provides a loopback path from the downstream RF interface 202 to the upstream RF interface 216 that can be used to monitor the operational status of the CMTS 200 when the CMTS 200 is operating in backup mode. FIG. 2B is a block diagram of the embodiment of a CMTS 200 shown in FIG. 2A while the CMTS 200 is operating in backup mode. The loopback path is shown in FIG. 2B using a dashed line. When such a loopback path is provided, the loopback switch circuit 240 decouples the downstream RF interface 202 and the upstream RF interface 216 from downstream ports 206 and upstream ports 216, respectively, and from the downstream test port 242 and the upstream test port 244. This decouples the downstream RF interface 202 and the upstream RF interface 216 from the HFC infrastructure 106.

In one embodiment that supports a DOCISIS standard, the amplified downstream RF signal output by the downstream RF interface 202 while the CMTS 200 is in active mode includes a downstream channel in the frequency range of approximately 88 megahertz to approximately 860 megahertz. However in such an embodiment, the upstream RF interface 216 expects to receive upstream RF signals containing a channel in the frequency range of 5 megahertz to 42 megahertz. Thus in such an embodiment, the downstream RF interface 202 includes the capability to output an amplified downstream RF signal in the frequency range expected by the upstream RF interface 216. In one implementation of such an embodiment, this is done by adjusting the output frequency output by the appropriate upconverter 212.

In one implementation, each modulator 208 includes the capability to generate and transmit a downstream test RF signal. The downstream test RF signal is looped back to one of the receivers 226 via the loopback path provided by the loopback switch circuit 240. In this way, the components in the loopback path can be tested. As noted above, the loopback switch circuit 240 includes the ability to selectively couple any one (or none) of the amplified downstream RF signals output by a respective amplifier 214 to any one amplifiers 220. FIG. 2C is a block diagram of the embodiment of a CMTS 200 shown in FIG. 2A while such CMTS 200 is operating in backup mode. A loopback path, different from the one shown in FIG. 2B, is shown in FIG. 2C using a dashed line.

In active mode, the receivers 226 of the CMTS 200 typically operate in a burst mode where bursts transmitted from cable modems are received and demodulated. In active mode, the modulators 208 typically transmit to cable modems in a continuous mode. In one implementation of the CMTS 200, the modulators 208 also have the ability to transmit in burst mode. In such an implementation, when the CMTS 200 is in backup mode and a loopback path between a modulator 208 and a receiver 226 is established, the modulator 208 is able to transmit in burst mode so that the receiver 226 can operate in burst mode, as is done in active mode. In another implementation, the modulator 208 is not able to transmit in burst mode. In such an implementation, when the CMTS 200 is in backup mode and a loopback path between a modulator 208 and a receiver 226 is established, the receiver 226 operates in a continuous receiver mode in order to receive the test RF signal transmitted over the loopback path.

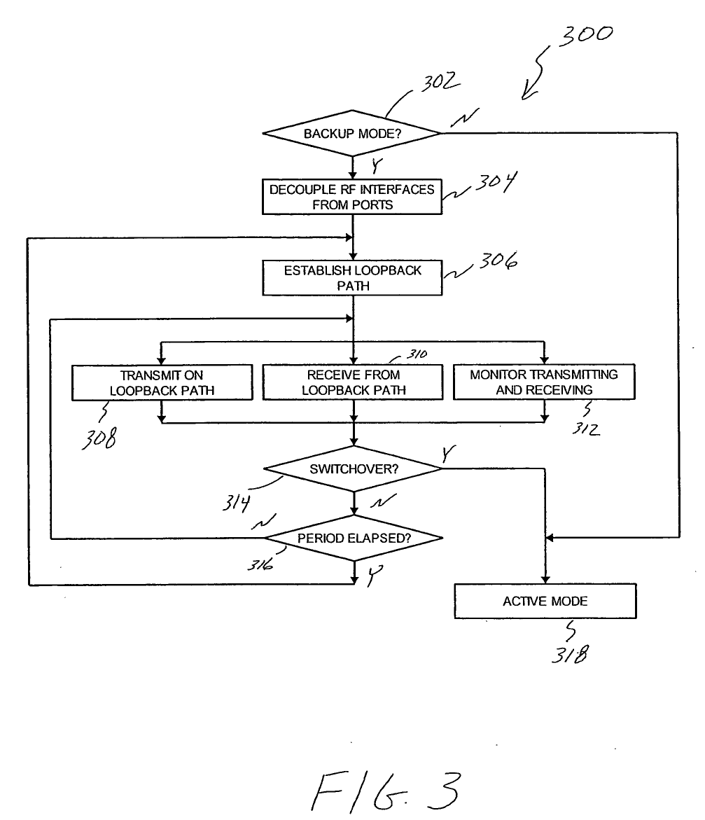

FIG. 3 is a flow diagram of one embodiment of a method 300 of monitoring a cable modem termination system while the cable modem termination system is in backup mode. Although the embodiment of method 300 shown in FIG. 3 is described here as being implemented using the cable system 100 and CMTS 200 shown in FIGS. 1 and 2A, respectively, other embodiments are implemented in other ways. In the embodiment shown in FIG. 3, at least a portion of the functionality is implemented by or under the control of a management module 126 and/or controller 234 of the CMTS 200 using, for example, appropriate software and/or firmware.

The embodiment of method 300 is executed for a particular CMTS 200 when the CMTS 200 is in backup mode (checked in block 302). For example, when the CMTS 200 is powered up, the CMTS 200 determines whether that CMTS 200 is supposed to operate in active mode or backup mode. In one implementation, the controller 234 of the CMTS 200 makes such a determination by communicating with the management module 126 over the management bus 132 and/or based on the chassis slot in which the CMTS 200 is inserted. If the CMTS 200 is not in backup mode, the CMTS 200 is in active mode (block 318).

When the CMTS 200 is operating in backup mode, the loopback switch circuit 240 decouples the downstream RF interface 202 and the upstream RF interface 216 of the CMTS 200 from the downstream ports 206 and the upstream ports 216, respectively, and from the downstream test port 242 and the upstream test port 244 (block 304). This decouples the downstream RF interface 202 and the upstream RF interface 216 from the HFC infrastructure 106.

The loopback switch circuit 240 establishes a loopback path between one of the modulators 208 and one of the receivers 226 (block 306). Then, for a predetermined period of time, the modulator 208 in the loopback path attempts to transmit a test RF signal containing test data on the loopback path (block 308) and the receiver 226 in the loopback path attempts to receive the transmitted test RF signal from the loopback path (block 310). In one implementation, the transmitted test RF signal is upconverted to a frequency within the frequency range expected by the receiver 226 (for example, within the frequency range of 5 megahertz to 42 megahertz). The transmitting and receiving using the loopback path is monitored (block 312). In one implementation, such monitoring includes determining how well the receiver 226 is able to receive the transmitted test RF signal, if at all, for example by analyzing a parameter such as signal-to-noise ratio or an adaptive equalizer value. Such monitoring also includes, for example, determining if the data extracted from the RF signal received by the receiver 226 matches the test data included in the test RF signal transmitted by the modulator 208.

This process of transmitting, receiving, and monitoring is performed until a switchover occurs (block 314). When a switchover occurs, the CMTS 200 enters active mode (checked in block 318). Otherwise, the transmitting, receiving, and monitoring continue for the current loopback path unless the predetermined period of time has elapsed for the current loopback path (checked in block 316). When the predetermined period of time has elapsed for the current loopback path, the loopback switch circuit 240 establishes a different loopback path between one of the modulators 208 and one of the receivers 226 (looping back to block 306). As described above, for a predetermined period of time, the modulator 208 in the loopback path attempts to transmit a test RF signal containing test data on the new loopback path (block 308) and the receiver 226 in the new loopback path attempts to receive the transmitted test RF signal from the new loopback path (block 310). The transmitting and receiving using the new loopback path is monitored as described above (block 312). In the embodiment shown in FIG. 3, method 300 cycles through each possible loopback path for each combination of modulator 208 and receiver 226. Each possible loopback path is tested by transmitting and receiving test data on that loopback path until a switchover occurs and the CMTS 200 enters active mode.

In this way, the status of each such loopback path and the corresponding downstream path and upstream path are tested and monitored while the CMTS 200 is in backup mode. Such monitoring is used to determine if all of the downstream paths and the upstream paths are operating in a manner that would allow the CMTS 200 to operate successfully in active mode in the event a switchover occurs. If that is not the case, appropriate alarm events are triggered or sent to a management application (not shown) and/or other actions are taken.

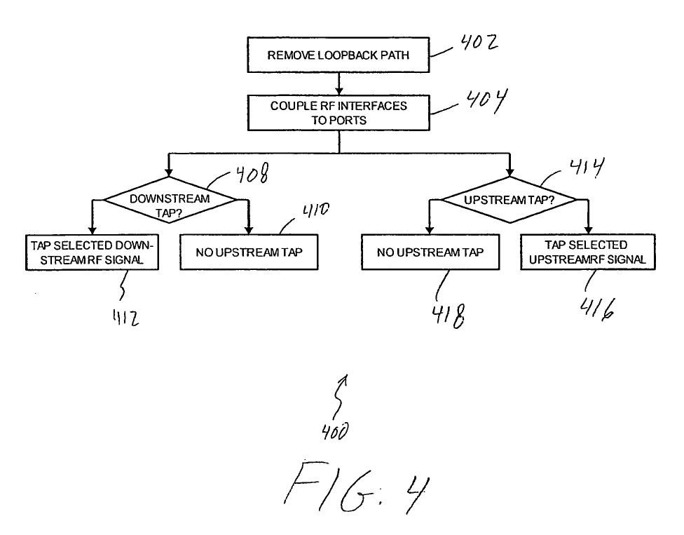

FIG. 4 is a flow diagram of one embodiment of a method 400 of operating a loopback switch circuit of a CMTS. Although the embodiment of method 400 shown in FIG. 4 is described here as being implemented using the cable system 100 and CMTS 200 shown in FIGS. 1 and 2A, respectively, other embodiments are implemented in other ways. In the embodiment shown in FIG. 4, at least a portion of the functionality is implemented by or under the control of a management module 126 and/or controller 234 of the CMTS 200 using, for example, appropriate software and/or firmware.

The embodiment of method 400 is executed for a particular CMTS 200 when the CMTS 200 is in active mode. When the CMTS 200 operates in active mode, the loopback switch circuit 240 removes any loopback paths that may exists in the loopback switch circuit 240 (block 402) and couples the downstream RF interface 202 and the upstream RF interface 216 of the CMTS 200 to the downstream ports 206 and the upstream ports 216, respectively (block 404).

If a downstream RF signal is to be tapped and monitored while the CMTS is in active mode (checked in block 406), the loopback switch circuit 240 taps the selected amplified downstream RF signal and couples that signal to the downstream test port 242 (block 408). In one exemplary usage scenario, a technician using management software to interact with the management module 136 instructs the CMTS 200 to output a particular downstream RF signal on the downstream test port 242. The technician can then attach test equipment to the downstream test port 242 to monitor the selected downstream RF signals. If a downstream RF signal is not tapped and monitored, no signal is coupled to the downstream test port 242 (block 410).

If an upstream RF signal is to be tapped and monitored while the CMTS is in active mode (checked in block 412), the loopback switch circuit 240 taps the upstream RF signal and couples that signal to the upstream test port 244 (block 414). In one exemplary usage scenario, a technician using management software to interact with the management module 136 instructs the CMTS 200 to output a particular upstream RF signal on the upstream test port 244. The technician can then attach test equipment to the upstream test port 244 to monitor the selected upstream RF signals. If an upstream RF signal is not tapped and monitored, no signal is coupled to the upstream test port 244 (block 416).

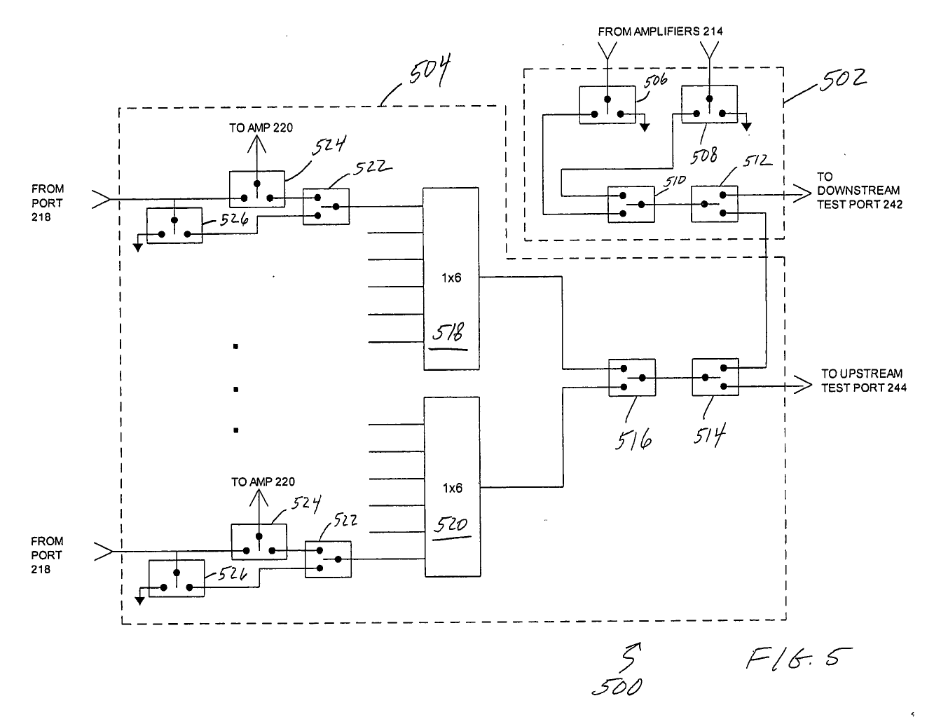

FIG. 5 is a block diagram of one embodiment of a loopback switch circuit 500. Although the embodiment of loopback switch circuit 500 shown in FIG. 5 is described here as being implemented in the cable system 100 and CMTS 200 shown in FIGS. 1 and 2A, respectively, other embodiments are implemented in other ways.

The loopback switch circuit 500 includes a downstream portion 502 and an upstream portion 504. The downstream portion 502 includes a switch 506 having a first terminal that is coupled to the output of one of the two amplifiers 214 included in the downstream RF interface 202 of the embodiment of CMTS 200 shown in FIG. 2A. The downstream portion 502 also includes a switch 508 having a first terminal that is coupled to the output of the other of the two amplifiers 214 included in the downstream RF interface 202. The switch 506 includes a second terminal that is coupled to a first terminal of a switch 510, and the switch 508 includes a second terminal that is coupled to a second terminal of the switch 510. Each of the switches 506 and 508 includes a third terminal that is coupled to chassis ground. In this way, switch 506 is able to selectively couple the output of one of the amplifier 214 to the first terminal of switch 510 or to chassis ground, and switch 508 is able to selectively couple the output of the other of the amplifier 214 to the second terminal of switch 510 or to chassis ground.

The switch 510 includes a third terminal that is coupled to a first terminal of a switch 512. In operation, the third terminal of switch 510 is selectively coupled to either the first terminal of switch 510 (which is selectively coupled to the output of one of the amplifiers 214) or the second terminal of switch 510 (which is selectively coupled to the output of the other of the amplifiers 214). The switch 512 includes a second terminal that is coupled to the downstream test port 242 of the downstream RF interface 202 of the embodiment of CMTS 200 shown in FIG. 2A. The switch 512 includes a third terminal that is coupled to the upstream portion 504 of the loopback switch circuit 500. In operation, the switch 512 is used to selectively couple the output of one of the amplifiers 214 either to the downstream test port 242 coupled to the second terminal or to upstream portion 504 of the loopback switch circuit 500 via the third terminal.

The upstream portion 504 of the loopback switch circuit 500 includes a switch 514 having a first terminal that is coupled to the third terminal of the switch 512. That is, the first terminal of the switch 514 is used to selectively receive the output of one of the amplifiers 214. The switch 514 includes a second terminal that is coupled to a first terminal of a switch 516. The switch 514 can be used to establish a connection between the first and second terminals of the switch 514 in order to couple an output of one of the amplifiers 214 to the first terminal of switch 516. The switch 516 has a second terminal that is coupled to a first terminal of a 1×6 switch 518. The switch 516 has a third terminal that is coupled to a first terminal of a 1×6 switch 520. In one implementation, a 1×8 switch is used for 1×6 switches 518 and 520, where only six terminals of the eight-terminal side of each 1×8 switch are used and the other two terminals are coupled to chassis ground. The switch 516 can be used to selectively couple the output of one of the upconverters 212 to one of the 1×6 switches 518 or 520.

The 1×6 switches 518 can selectively couple the output of one of the amplifiers 214 received on the first terminal of that switch 518 to one of six terminals on the other side (that is, the six-terminal side) of the 1×6 switch 518. Each of the six terminals on the six-terminal side of the 1×6 switch 518 can be selectively coupled to the input of one of the analog-to-digital converters 222 in the upstream RF interface 216 of the embodiment of CMTS 200 shown in FIG. 2A. Likewise, each of the six terminals on the six-terminal side of the 1×6 switch 520 can be selectively coupled to the input of one of the analog-to-digital converters 222 in the upstream RF interface 216 of the embodiment of CMTS 200 shown in FIG. 2A. Each of the six terminals on the six-terminal side of the 1×6 switch 518 and the 1×6 switch 520 is coupled to a first terminal of a respective switch 522. Each switch 522 includes a second terminal that is coupled to a first terminal of a respective switch 524. Each switch 524 includes a second terminal that is coupled to an input of the respective analog-to-digital converter 222. In this way, the output of an amplifier 214 can be selectively coupled to the input of any of the analog-to-digital converters 222 in the upstream RF interface 216 in order to establish a loopback path.

The upstream portion 504 of the loopback switch circuit 500 also allows any one of the upstream RF signals received from a respective one of the upstream ports 218 to be selectively coupled to the upstream test port 224. Each upstream port 218 is coupled to a third terminal of the respective switch 524 so that the upstream RF signal received from that port 218 can be selectively coupled to the input of the respective analog-to-digital converter 222. Such an upstream path is established, for example, when the CMTS 200 is in active mode.

Each upstream port 218 is also coupled to a respective switch 526. Each switch 526 includes a first terminal that is tapped into the respective upstream port 218 and receives the upstream RF signal from that port 218. Each switch 526 also includes a second terminal that can be used to selectively couple the tapped upstream RF signal to a third terminal of switch 522 when the upstream RF signal received on the first terminal is to be provided to the upstream test port 244. Each switch 526 also includes a third terminal that is coupled to chassis ground. The switch 526 can selectively couple the first terminal of switch 526 to the third terminal of switch 526 when the upstream RF signal received on the first terminal is not provided to the upstream test port 244.

The switch 522 can selectively couple the tapped upstream RF signal received on its third terminal to one of the terminals from the six-terminal side of the respective 1×6 switch 518 or 520. The 1×6 switch 518 can selectively couple the tapped upstream RF signal received on one of the terminals on the six-terminal side of that switch 518 to the second terminal of the switch 516, and the 1×6 switch 520 can selectively couple the tapped upstream RF signal received on one of the terminals on the six-terminal side of that switch 520 to the third terminal of the switch 516. Switch 516 is able to selectively couple the tapped upstream RF signal received from either of the switches 518 or 520 to the second terminal of switch 514. Switch 514 includes a third terminal that is coupled to the upstream test port 244. The switch 514 can selectively couple the tapped upstream RF signal received from the switch 516 to the upstream test port 244 via the third terminal of switch 514. In this way, the tapped upstream RF signal is coupled to the upstream test port 244 via the loopback switch circuit 500.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A cable modem termination system, comprising:
an upstream radio frequency interface having a plurality of upstream radio frequency signal inputs; and
a downstream radio frequency interface having a downstream radio frequency signal output; and
wherein the downstream radio frequency signal output is selectively coupled to at least one of the plurality of upstream radio frequency signal inputs.

2. The cable modem termination system of claim 1, further comprising a loopback switch to selectively couple the downstream radio frequency signal output to the at least one of the plurality of upstream radio frequency signal inputs.

3. The cable modem termination system of claim 2, wherein the loopback switch selectively couples the plurality of upstream radio frequency inputs to a plurality of upstream radio frequency signals received from a cable network.

4. The cable modem termination system of claim 2, wherein the downstream radio frequency interface generates a downstream radio frequency signal that is output on the downstream radio frequency signal output, wherein the loopback switch selectively couples the downstream radio frequency signal output to a cable network.

5. The cable modem termination system of claim 2, further comprising a test port, wherein the loopback switch selectively couples the downstream radio frequency signal output to the test port.

6. The cable modem termination system of claim 2, further comprising a plurality of upstream ports to receive a plurality of upstream radio frequency signals from a cable network.

7. The cable modem termination system of claim 6, further comprising a test port, wherein the loopback switch selectively couples the test port to at least one of the upstream ports.

8. The cable modem termination system of claim 1, wherein the cable modem termination system transmits a test signal from the downstream radio frequency interface to the upstream radio frequency interface when the downstream radio frequency signal output is coupled to the at least one of the plurality of upstream radio frequency signal inputs.

9. The cable modem termination system of claim 8, wherein the test signal transmitted from the downstream radio frequency interface includes a channel a frequency range compatible with the upstream radio frequency interface.

10. A system comprising:
a plurality of cable modem termination systems, each cable modem termination system comprising:
an upstream radio frequency interface having a plurality of upstream radio frequency signal inputs; and
a downstream radio frequency interface that generates a downstream radio frequency signal and comprising a downstream radio frequency output on which the downstream radio frequency signal is output; and
wherein when each of the plurality of cable modem termination systems acts as an active cable modem termination system, that cable modem termination system is selectively coupled to a cable network and the network interface in order to receive a plurality of upstream radio frequency signals from the cable network and to transmit a downstream radio frequency signal to the cable network and to receive downstream network data from the first network and transmit upstream network data to the first network; and
wherein when each of the plurality of cable modem termination systems acts as a backup cable modem termination system, the downstream radio frequency signal output of that cable modem termination system is selectively coupled to at least one of the plurality of upstream radio frequency signal inputs of that cable modem termination system.

11. The system of claim 10, further comprising a network interface to couple the system to a first network.

12. The system of claim 11, further comprising a backplane to couple the plurality of cable modem termination systems and the network interface to one another.

13. The system of claim 11, wherein the first network is in communication with the Internet.

14. The system of claim 11, further comprising a management module coupled to the plurality of cable modem termination systems and the network interface.

15. The system of claim 14, wherein the management module is coupled to the plurality of cable modem termination systems and the network interface over a management bus.

16. A method comprising:
determining if a cable modem termination system is in a first mode;
when the cable modem termination system is in the first mode:
establishing a loopback path between a downstream radio frequency interface of the cable modem termination system and an upstream radio frequency interface of the cable modem termination system; and
transmitting a radio frequency signal on the loopback path.

17. The method of claim 16, further comprising, when the cable modem termination system is in the first mode, receiving the radio frequency signal from the loopback path.

18. The method of claim 17, further comprising, when the cable modem termination system is in the first mode, monitoring the transmitting and receiving on the loopback path.

19. The method of claim 16, wherein the first mode is a backup mode.

20. The method of claim 16, further comprising, when the cable modem termination system leaves the first mode, removing the loopback path.

21. The method of claim 16, wherein establishing the loopback path between the downstream radio frequency interface of the cable modem termination system and the upstream radio frequency interface of the cable modem termination system comprises establishing a plurality of loopback paths between the downstream radio frequency interface of the cable modem termination system and the upstream radio frequency interface of the cable modem termination system.

22. A cable modem termination system, comprising:
an upstream means for receiving a plurality of upstream radio frequency signals;
a downstream means for generating a downstream radio frequency signal; and
a loopback means for selectively coupling the downstream radio frequency signal to the upstream means.
